(19) United States
(12) Patent Application Publication
(10) Pub. No.: US 2026/0239131 A1
(43) Pub. Date: Aug. 13, 2026

(54) BASE STATION, USER EQUIPMENT, AND METHOD FOR CONDITIONAL HANDOVER WITH CONDITIONAL PSCELL ADDITION/CHANGE

(71) Applicant: SHARP KABUSHIKI KAISHA, Sakai City, Osaka (JP)

(72) Inventors: HE-HSUAN LIU, Taipei (TW); MEI-JU SHIH, Taipei (TW); CHIA-HUNG LIN, Taipei (TW)

(21) Appl. No.: 19/471,058

(22) PCT Filed: Mar. 29, 2024
(86) PCT No.: PCT/CN2024/084684

§ 371 Date: Sep. 30, 2025

Related U.S. Application Data
(60) Provisional application No. 63/455,938, filed on Mar. 30, 2023.

(51) Int. Cl. H04W 36/00; H04W 36/36

(52) U.S. Cl. CPC H04W 36/00835; H04W 36/0058; H04W 36/362

(57) ABSTRACT

A method performed by a base station (BS) for Conditional Handover (CHO) with Conditional Primary Secondary Cell Group (SCG) Cell (PS-Cell) Addition/Change (CPAC) is provided. The method includes receiving, from a source Master Node (MN), a first message indicating the BS as a candidate target MN for a CHO procedure; transmitting, to a second BS, a second message indicating the second BS as a candidate target Secondary Node (SN) for a CPAC procedure, the second message including a measurement result associated with the second BS; receiving, from the second BS, a first acknowledgement message including a first radio resource configuration corresponding to an SCG and a PSCell; and transmitting, to the source MN, a second acknowledgement message including a second radio resource configuration corresponding to a Master Cell Group (MCG) and a Primary Cell (PCell), the first radio resource configuration, and an execution condition for the CPAC procedure.

### FIELD

The present disclosure is related to wireless communication and, more specifically, to, base station (BS), user equipment (UE), and method for Conditional Handover (CHO) with Conditional Primary Secondary Cell Group (SCG) Cell (PSCell) Addition/Change (CPAC), in cellular wireless communication networks.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to a BS, a UE, and a method for CHO with CPAC in cellular wireless communication networks.

In a first aspect of the present application, a method performed by a BS for CHO with CPAC is provided. The method includes receiving, from a source Master Node (MN), a first message indicating the BS as a candidate target MN for a CHO procedure; transmitting, to a second BS, a second message indicating the second BS as a candidate target Secondary Node (SN) for a CPAC procedure, the second message including a measurement result associated with the second BS; receiving, from the second BS, a first acknowledgement message including a first radio resource configuration corresponding to an SCG and a PSCell associated with the second BS; and transmitting, to the source MN, a second acknowledgement message including an identifier (ID) of a Primary Cell (PCell), a second radio resource configuration corresponding to a Master Cell Group (MCG) and the PCell associated with the BS, an ID of the PSCell, the first radio resource configuration, and an execution condition for the CPAC procedure.

In some implementations of the first aspect, the measurement result includes signal quality of cells in the second BS measured by a UE served by the source MN.

In some implementations of the first aspect, the first message includes the measurement result associated with the second BS and a second measurement result associated with the BS.

In some implementations of the first aspect, the second message and the first acknowledgement message are transmitted on an Xn interface between the BS and the second BS.

In a second aspect of the present application, a BS for CHO with CPAC is provided. The BS includes at least one processor and at least one memory coupled to at least one processor. The at least one memory stores computer-executable instructions that, when executed by the at least one processor, cause the BS to: receiving, from a source MN, a first message indicating the BS as a candidate target MN for a CHO procedure; transmitting, to a second BS, a second message indicating the second BS as a candidate target SN for a CPAC procedure, the second message including a measurement result associated with the second BS; receiving, from the second BS, a first acknowledgement message including a first radio resource configuration corresponding to an SCG and a PSCell associated with the second BS; and transmitting, to the source MN, a second acknowledgement message including an ID of a PCell, a second radio resource configuration corresponding to an MCG and the PCell associated with the BS, an ID of the PSCell, the first radio resource configuration, and an execution condition for the CPAC procedure.

In a third aspect of the present application, a UE for CHO with CPAC is provided. The UE includes at least one processor and at least one memory coupled to at least one processor. The at least one memory stores computer-executable instructions that, when executed by the at least one processor, cause the UE to: receive, from a source serving cell, a first RRC message including a CHO configuration and a CPAC configuration associated with the CHO configuration, where the CHO configuration indicates a first radio resource configuration corresponding to a target MCG and a PCell for a CHO procedure, a first triggering condition for executing the CHO procedure, and a second triggering condition associated with the CPAC configuration, and the CPAC configuration indicates a second radio resource configuration corresponding to a target SCG and a PSCell for a CPAC procedure and a third triggering condition for executing the CPAC procedure; evaluate the first triggering condition; evaluate the second triggering condition; start evaluating the third triggering condition upon determining that the second triggering condition is satisfied; and stop evaluating the third triggering condition upon determining that the second triggering condition is not satisfied.

In some implementations of the third aspect, the computer-executable instructions that, when executed by the at least one processor, further cause the UE to: execute the CHO procedure upon determining that the first triggering condition is satisfied; and execute the CPAC procedure upon determining that the third triggering condition is satisfied.

In some implementations of the third aspect, the first RRC message further includes a second CHO configuration and a second CPAC configuration associated with the second CHO configuration, and the CPAC configuration is not associated with the second CHO configuration.

In some implementations of the third aspect, the second CHO configuration indicates a fourth triggering condition for executing a second CHO procedure and a fifth triggering condition associated with the second CPAC configuration, and the third triggering condition is not evaluated by the UE in a case that the second triggering condition is not satisfied and the fifth triggering condition is satisfied.

In some implementations of the third aspect, the second triggering condition corresponds to a quality of signal received from the PCell.

In some implementations of the third aspect, the second triggering condition is indicated by a measurement ID in the CHO configuration.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a CHO with CPAC procedure according to an example implementation of the present disclosure.

FIG. 2 is a flowchart illustrating a method/process for CHO with CPAC performed by a BS, according to an example implementation of the present disclosure.

FIG. 3 is a flowchart illustrating a method/process for CHO with CPAC performed by a UE, according to an example implementation of the present disclosure.

FIG. 4 illustrates structure of an RRC message including a CHO with CPAC configuration, according to an example implementation of the present disclosure.

FIG. 5 illustrates structure of a Linking Message according to an example implementation of the present disclosure.

FIG. 6 is a block diagram illustrating a node for wireless communication, according to an example implementation of the present disclosure.

### DESCRIPTION

Some abbreviations used in the present disclosure include:

### Abbreviation Full Name

3GPP 3^{rd} Generation Partnership Project
5G 5^{th} Generation
5GC 5G Core Network
ACK Acknowledgment
AS Access Stratum
BS Base Station
BWP Bandwidth Part
C-RNTI Cell Radio Network Temporary Identifier
CA Carrier Aggregation
CC Component Carrier
CG Configured Grant
CHO Conditional Handover
CMAS Commercial Mobile Alert System
CN Core Network
CPA Conditional PSCell Addition
CPAC Conditional PSCell Addition/Change
CPC Conditional PSCell Change
CSI-RS Channel State Information Reference Signal
DC Dual Connectivity
DCI Downlink Control Information
DL Downlink
DRB Data Radio Bearer
EN-DC E-UTRA NR Dual Connectivity
EPC Evolved Packet Core
ETWS Earthquake and Tsunami Warning System
E-UTRA Evolved Universal Terrestrial Radio Access
FR Frequency Range
ID Identifier
IE Information Element
L1 Layer 1
L3 Layer 3
LTE Long Term Evolution
MAC Medium Access Control
MAC CE MAC Control Element
MCG Master Cell Group
MIB Master Information Block
MN Master Node
MR-DC Multi-Radio Dual Connectivity
NAS Non Access Stratum
NDI New Data Indicator
NE-DC NR E-UTRA Dual Connectivity
NG-RAN Next Generation Radio Access Network
NGEN-DC NG-RAN E-UTRA-NR Dual Connectivity
NPN Non-Public Network
NR New Radio
NR-DC NR-NR Dual Connectivity
NW Network
OFDM Orthogonal Frequency Division Multiplexing
PCell Primary Cell
PCI Physical Cell ID
PDCCH Physical Downlink Control Channel
PDSCH Physical Downlink Shared Channel
PHY Physical (layer)
PLMN Public Land Mobile Network
PNI-NPN Public Network Integrated NPN
PRACH Physical Random Access Channel
PSCell Primary SCG Cell
PUCCH Physical Uplink Control Channel
PUSCH Physical Uplink Shared Channel
QoS Quality of Service
RA Random Access
RAN Radio Access Network
RAR Random Access Response
RAT Radio Access Technology
Re Release
RF Radio Frequency
RNTI Radio Network Temporary Identifier
RRC Radio Resource Control
RRM Radio Resource Management
RS Reference Signal
RSRP Reference Signal Received Power
RSRQ Reference Signal Received Quality
RSSI Received Signal Strength Indication
SCell Secondary Cell
SCG Secondary Cell Group
SI System Information
SIB System Information Block
SINR Singal to Interference plus Noise Ratio
SN Secondary Node
SNPN Standalone NPN
SSB Synchronization Signal Block
TA Tracking Area
TB Transport Block
TRP Transmission Reception Point
TS Technical Specification
TTT Time-to-Trigger
UE User Equipment
UL Uplink
URLLC Ultra-Reliable and Low-Latency Communication

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

Examples of some selected terms in the present disclosure are provided as follows.

The network (NW), cell, camped cell, serving cell, base station, gNB, eNB and ng-eNB may be used interchangeably in the present disclosure. In some implementations, some of these items may refer to the same network entity.

The RAT may be (but not limited to) NR, LTE, E-UTRA connected to 5GC, LTE connected to 5GC, E-UTRA connected to EPC, and LTE connected to EPC. The mechanism in this disclosure may be applied for UEs in public networks, or in private network (e.g., NPN, SNPN, PNI-NPN).

The mechanism in this disclosure may be used for licensed frequency and/or unlicensed frequency.

System information (SI) may refer to MIB, SIB1, and other SI. Minimum SI may include MIB and SIB1. Other SI may refer to SIB3, SIB4, SIB5, and other SIB(s).

Dedicated signaling may refer to (but not limited to) RRC message(s). For example, RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message.

The RRC_CONNECTED UE, RRC_INACTIVE UE, and RRC_IDLE UE may apply the implementations in this disclosure.

An RRC_CONNECTED UE may be configured with an active BWP with common search space configured to monitor system information or paging.

The UE may be served by a cell, e.g., serving cell. The serving cell may serve (but not limited to) an RRC_CONNECTED UE. The serving cell may be (but not limited to) a suitable cell.

The UE may camp on a cell, e.g., camped cell. The camped cell may be a suitable cell or an acceptable cell.

A suitable cell is a cell on which a UE may camp. The UE may consider a cell as suitable if the following conditions are fulfilled: (1) The cell is part of either the selected PLMN or the registered PLMN or PLMN of the Equivalent PLMN list, and (2) The cell criteria of the cell are fulfilled. Furthermore, according to the latest information provided by NAS, the suitable cell is not barred. The suitable cell is part of at least one TA that is not part of the list of “Forbidden Tracking Areas”, which belongs to a PLMN that fulfils the condition (1). The target cell may be a suitable cell.

An acceptable cell is a cell on which the UE may camp to obtain limited service (originate emergency calls and receive ETWS and CMAS notifications). Such a cell may fulfil the following requirements, which is the minimum set of requirements to initiate an emergency call and to receive ETWS and CMAS notification in an NR network: (1) the cell is not barred, and/or (2) the cell selection criteria are fulfilled.

PCell: The MCG cell, operating on the primary frequency, in which the UE either performs the initial connection establishment procedure or initiates the connection re-establishment procedure.

PSCell: For dual connectivity operation, the SCG cell in which the UE performs random access when performing the Reconfiguration with Sync procedure.

Serving Cell: For a UE in RRC_CONNECTED not configured with CA/DC there is only one serving cell including the primary cell. For a UE in RRC_CONNECTED configured with CA/DC the term ‘serving cells’ may be used to denote the set of cells including the Special Cell(s) and all secondary cells.

Secondary Cell: For a UE configured with CA, a cell providing additional radio resources on top of the Special Cell.

Special Cell (SpCell): For Dual Connectivity operation the term Special Cell refers to the PCell of the MCG or the PSCell of the SCG, otherwise the term Special Cell refers to the PCell.

Master Cell Group (MCG): in MR-DC, a group of serving cells associated with the Master Node, including the SpCell (e.g., PCell) and optionally one or more SCells.

Master Node (MN): in MR-DC, the radio access node that provides the control plane connection to the core network. It may be a Master eNB (in EN-DC), a Master ng-eNB (in NGEN-DC) or a Master gNB (in NR-DC and NE-DC).

Secondary Cell Group (SCG): in MR-DC, a group of serving cells associated with the Secondary Node, including the SpCell (e.g., PSCell) and optionally one or more SCells.

Secondary Node (SN): in MR-DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

The terms “serving cell”, “TRP associated with the PCI of the serving cell”, and “TRP associated with the serving cell” may be used interchangeably in this disclosure.

The terms “target cell”, “TRP associated with a PCI different from the PCI of the serving cell”, and “TRP associated with the target cell” may be used interchangeably in this disclosure.

The serving cell in the implementations in this disclosure may be a PCell, SCell, or PSCell.

The term “source node” may be interpreted as a source MN, a source PCell, a source PSCell, or a source gNB.

The target cell in the implementations in this disclosure may be a PCell, SCell or PSCell.

The system information may be associated with the serving cell and/or the system information may be associated with the target cell.

The term “CPAC” may be interpreted as CPA, CPC, or both.

A PSCell may be associated with multiple CPAC Candidate Configurations, which are further associated with different CHO Candidate Configurations. The terms “associated PSCell” and “associated CPAC Candidate Configuration” may be used to indicate the PSCell and the CPAC Candidate Configuration which are associated with a given CHO Candidate Configuration and/or a given PCell associated with the CHO Candidate Configuration.

A CHO Configuration may include a CHO Configuration ID, a measurement ID for CHO pre-condition, a measurement ID for CHO condition, and a CHO conditional configuration. A CHO Configuration ID may be used to index the CHO Configuration. A CHO pre-condition may be the condition that triggers the UE to start to evaluate the CPAC conditions of the CPAC Candidate Configuration associated with the CHO Configuration. A CHO condition may be the condition that triggers the UE to start to perform the CHO execution to the PCell associated with the CHO Configuration. A CHO conditional configuration may be the configuration that the UE applies during the CHO execution.

A UE may store and/or apply the information/configuration of the CHO Configuration received from the source node. In this disclosure, “CHO Candidate Configuration” may be used to represent the stored information/configuration of the CHO Configuration ID, the CHO pre-condition, the CHO condition, and the CHO conditional configuration encapsulated in the CHO Configuration.

A CPAC Configuration may include a CPAC Configuration ID, a measurement ID for CPAC pre-condition, a measurement ID for CPAC condition, and a CPAC conditional configuration. A CPAC Configuration ID may be used to index the CPAC Configuration. A CPAC pre-condition may be the condition that triggers the UE to determine the CPAC Candidate Configuration as a Pre-Qualified CPAC Candidate Configuration. A CPAC condition may be the condition that triggers the UE to determine the CPAC Candidate Configuration and Pre-Qualified CPAC Candidate Configuration as a Qualified CPAC Candidate Configuration. A CPAC conditional configuration may be the configuration that the UE applies during the CPAC execution.

A UE may store and/or apply the information/configuration of the CPAC Configuration received from the source node. In this disclosure, “CPAC Candidate Configuration” may be used to represent the stored information/configuration of the CPAC Configuration ID, the CPAC pre-condition, the CPAC condition, and the CPAC conditional configuration encapsulated in the CPAC Configuration.

A Linking Message may include a list of pairs of CHO Configuration ID and CPAC Configuration ID, and may include the priority instruction. In the Linking Message, if a CHO Configuration ID and a CPAC Configuration ID are paired, the CHO Configuration with the CHO Configuration ID and the CPAC Configuration with the CPAC Configuration ID are associated for the CHO with CPAC procedure. The priority instruction may be a list of prioritization criteria index associated with the CHO Configurations. The priority instruction may indicate the prioritization criterion for the selection of target PSCell when the CHO condition of the associated CHO Candidate Configuration is triggered and multiple CPAC conditions of the CPAC Candidate Configuration associated with the CHO Candidate Configuration are triggered. For example, a prioritization criteria index equal to 1 may indicate prioritizing the PSCells according to the latest measurement values. For example, a prioritization criteria index equal to 2 may indicate prioritizing the PSCells according to the lengths of the CPAC condition holding time.

A UE may store and/or apply the information/configuration of the Linking Message received from the source node. In this disclosure, “Linking Configuration” may be used to represent the stored information/configuration of the list of pairs of CHO Configuration ID and CPAC Configuration ID.

A gNB/cell may configure the priority instruction via a separate RRC message and/or IE. In this disclosure, “Priority Message” may be used to represent this RRC message and/or IE transmitted from the gNB/cell. A UE may store and/or apply the information/configuration of the Priority Message received from the source node. In this disclosure, “Priority Instruction” may be used to represent the stored information/configuration of the list of prioritization criteria associated with the CHO Candidate Configurations.

In wireless cellular networks, mobile devices (e.g., UE) may move from a cell to another due to their mobility. When a mobile device moves from a serving cell to a neighbor cell, a mobility event may occur, e.g., the quality of signal received from the source cell falls below a threshold for a period. Then, a handover procedure may be needed to ensure that the mobile device can continue the ongoing service in the neighbor cell. The handover procedure may be triggered by Layer 3 (L3) measurements and completed by RRC signaling.

To further enhance the robustness of the handover procedure, a CHO procedure was proposed to ensure that a mobile device is configured with a configuration of a target cell in advance. For example, the target cell for the CHO procedure is configured when the signal quality between the mobile device and the source cell is still stable.

There is existing regular handover procedure for MR-DC, e.g., the RRC Reconfiguration messages configuring the change of PCell and PSCell, and the addition and/or the release of SCells. However, CHO and MR-DC cannot be configured simultaneously according to the current technical specification. The restriction limits the usefulness of the CHO feature when MR-DC is configured. As a result, for the new release of the technical specification, it is desirable to investigate how to specify the simultaneous configuration of CHO and MR-DC to enhance the mobility robustness.

It is preferable to specify the simultaneous configuration of CHO and MR-DC. However, only specifying the simultaneous configuration of CHO and MR-DC may not be sufficient to optimize the MR-DC mobility since the signal quality of the conditionally configured PSCell may not be the best when the mobile device accesses the target PCell. In such cases, the throughput of the mobile device may be influenced. As a result, CHO with CPAC is considered as an enhancement.

The CHO with CPAC may involve CHO and CPAC Configuration Step, CHO and CPAC Evaluation Step, and CHO and CPAC Execution Step. However, the configuration, the evaluation, and the execution procedure were not specified in detail in the technical specification. In this disclosure, how to flexibly configure the CHO and CPAC configuration to the mobile device and how to evaluate the CHO and CPAC with less measurement overhead are disclosed.

CHO with CPAC

CHO including target MCG and candidate SCGs for CPC/CPA in NR-DC may be referred to as “CHO with CPAC”. CHO with CPAC may be a procedure involving, but not limited to, RRC configuration step, CHO with CPAC evaluation step, and CHO with CPAC execution step. In this disclosure, “CHO including target MCG and candidate SCGs for CPC/CPA in NR-DC” and “CHO with CPAC” may be used interchangeably.

### Scenario

In this disclosure, at least the following scenarios are considered. A network includes multiple cells, and a UE supports the MR-DC configuration. The UE may receive service from at least two RAN nodes, e.g., an MN including an MCG and at least one SN including an SCG. In this disclosure, the terms “MN” and “master gNB” may be used interchangeably, and the terms “SN” and “secondary gNB” may be used interchangeably. The UE may be equipped with multiple receivers and transmitters, and the UE may be capable of supporting the MR-DC dedicated configurations. The network, having the information that the UE is capable of supporting MR-DC, may configure the UE with the MR-DC configuration (e.g., the SCG configuration), which is encapsulated in an RRC Reconfiguration message and is transmitted from the serving gNB/cell to the UE. In the considered scenarios, the UE may operate with MR-DC configuration if MR-DC is configured by the network to the UE, or may not operate with MR-DC configuration if MR-DC is not configured by the network to the UE.

If the UE is configured and operating with MR-DC, the network may utilize radio resources provided by two distinct schedulers, located in two different RAN nodes. The UE may maintain the control and user plane connection to the PCell in the MCG and to the PSCell in the SCG. For the user plane, from the perspective of UE, there may be three bearer types: MCG bearer, SCG bearer, and split bearer. From the perspective of network, each bearer may be terminated either in the MN or in the SN.

In this disclosure, the term “source node” may be used to represent the source MN, the source SN, the source gNB, the source PCell, and/or the source PSCell.

CHO with CPAC Procedure

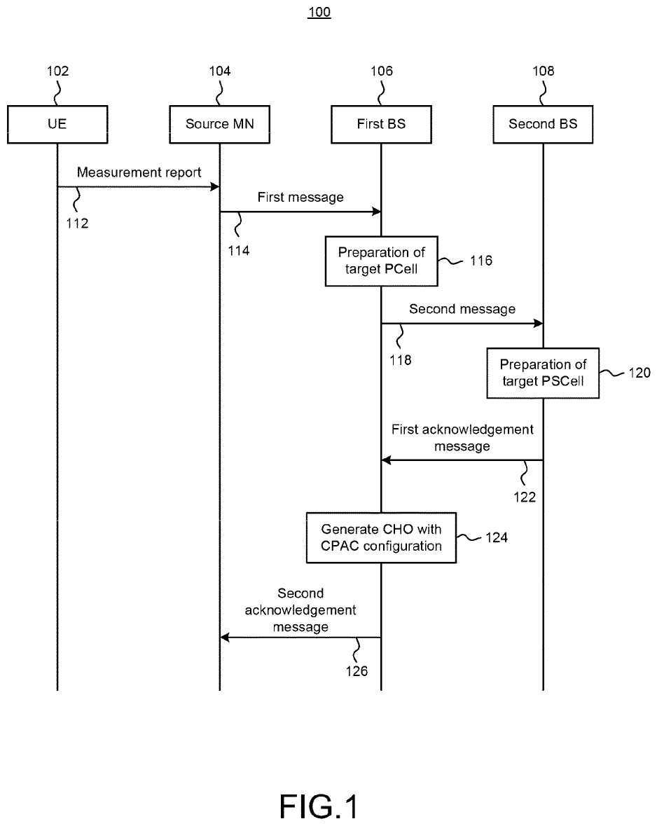

FIG. 1 illustrates a CHO with CPAC procedure 100 according to an example implementation of the present disclosure. The UE 102 may be served by the source MN 104. The UE 102 may measure signal quality of multiple cells associated with multiple base stations. For example, the UE 102 may measure signal quality of cells in the first BS 106 and cells in the second BS 108. The UE 102 may also measure signal quality of other base stations not shown in FIG. 1. These measurement result from the UE 102 may help the UE 102 to perform a handover procedure to switch from the source MN 104 to another BS.

In action 112, the UE 102 may transmit a measurement report to the source MN 104. The measurement report may include measurement results related to the first BS 106, the second BS 108, and other base stations not shown in FIG. 1. The source MN 104 may determine which base station act as a candidate target MN for a CHO procedure based on the measurement report received in action 112. For example, the source MN 104 may select the first BS 106 as the candidate target MN.

In action 114, the source MN 104 may transmit, to the first BS 106, a first message indicating the first BS 106 as a candidate target MN for a CHO procedure. The first message may be referred to as a handover request message. The first message may also be referred to as a CHO preparation message. In some implementations, the first message may include a first measurement result associated with the first BS 106 and a second measurement result associated with the second BS 108.

In action 116, the first BS 106 may perform procedures related to preparation of the target PCell. For example, the first BS 106 may determine candidate target PCells and MCGs and prepare radio resources for each PCell and MCG. In addition, upon receiving the first message, the first BS 106 may find one or more candidate target SN for a CPAC procedure. For example, the first BS 106 may select the second BS 108 as the candidate target SN. In some implementations, there may be more than one candidate target SNs selected by the first BS 106.

In action 118, the first BS 106 may transmit, to the second BS 108, a second message indicating the second BS 108 as a candidate target SN for a CPAC procedure. The second message may include a measurement result associated with the second BS 108. The measurement result may include signal quality of cells in the second BS 108 measured by the UE 102 served by the source MN 104. The second message may be referred to as a handover request for SN message. Because the first BS 106 requires the second BS 108 to prepare radio resources for the candidate target SN, the first BS 106 transmits the measurement result associated with the second BS 108 to the second BS 108. The second message may be transmitted on an Xn interface between the first BS 106 and the second BS 108.

In some implementations, there may be a third BS acting as the candidate target SN. The first BS 106 may also transmit, to the third BS, a third message indicating the third BS as a candidate target SN for the CPAC procedure. The third message may include a measurement result associated with the third BS. The third message may also be referred to as a handover request for SN message.

In action 120, the second BS 108 may perform procedures related to preparation of the target PSCell. For example, the second BS 106 may determine candidate target PSCells and SCGs and prepare radio resources for each PSCell and SCG.

In action 122, the first BS 106 may receive, from the second BS 108, a first acknowledgement message including a first radio resource configuration corresponding to an SCG and a PSCell associated with the second BS 108. The first acknowledgment message may be referred to as a handover request SN acknowledgement message or a handover request SN ACK message. In some implementations, there may be a third BS acting as the candidate target SN. The first BS 106 may also receive, from the third BS, a handover request SN ACK message including a radio resource configuration corresponding to an SCG and a PSCell associated with the third BS. The first acknowledgment message may include information associated with prepared PSCells, SCGs, and corresponding radio resource configuration. The first acknowledgment message may be transmitted on an Xn interface between the first BS 106 and the second BS 108.

In action 124, the first BS 106 may utilize information received from the second BS 106 (and possibly also the third BS) along with its own information to generate a CHO with CPAC configuration.

In action 126, the first BS 106 may transmit, to the source MN 104, a second acknowledgement message including an ID of the PCell (e.g., the prepared PCell in action 116), a second radio resource configuration corresponding to the MCG and the PCell associated with the first BS 106, an ID of the PSCell (e.g., the prepared PSCell in action 120), the first radio resource configuration (which corresponds to the SCG and the PSCell associated with the second BS 108), and an execution condition for the CPAC procedure. The second acknowledgment message may be referred to as a handover request acknowledgement message or a handover request ACK message. It should be noted that information related to CHO and information related to CPAC (such as execution condition on the associated PSCells) are encapsulated in a single message by the candidate target MN (e.g., the first BS 106). The information related to CPAC is not transmitted between the candidate target SN (e.g., the second BS 108) and the source MN 104.

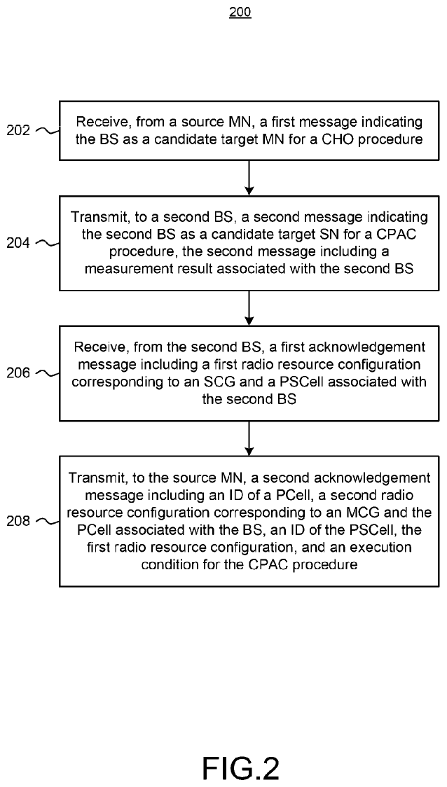

FIG. 2 is a flowchart 200 illustrating a method/process for CHO with CPAC performed by a BS, according to an example implementation of the present disclosure. In action 202, the BS may receiving, from a source MN, a first message indicating the BS as a candidate target MN for a CHO procedure. Action 202 may correspond to action 114 illustrated in FIG. 1. In action 204, the BS may transmit, to a second BS, a second message indicating the second BS as a candidate target SN for a CPAC procedure, the second message including a measurement result associated with the second BS. Action 204 may correspond to action 118 illustrated in FIG. 1.

In action 206, the BS may receive, from the second BS, a first acknowledgement message including a first radio resource configuration corresponding to an SCG and a PSCell associated with the second BS. Action 206 may correspond to action 122 illustrated in FIG. 1. In action 208, the BS may transmit, to the source MN, a second acknowledgement message including an ID of a PCell, a second radio resource configuration corresponding to an MCG and the PCell associated with the BS, an ID of the PSCell, the first radio resource configuration, and an execution condition for the CPAC procedure. Action 208 may correspond to action 126 illustrated in FIG. 1.

The technical problem addressed by the method illustrated in FIG. 2 is facilitating a CHO with CPAC in a wireless communication network. By receiving and transmitting specific messages between the source MN, the candidate target MN, the candidate target SN, the method enables seamless handover and cell configuration while minimizing signaling overhead. Specifically, the measurement result associated with the candidate target SN is transmitted from the candidate target MN to the candidate target SN. The candidate target MN generates a CHO with CPAC configuration and then transmits a single message including the CHO with CPAC configuration to the source MN. The CHO with CPAC configuration includes execution conditions on the associated PSCells (for CPAC). The method reduces signaling overhead and ensures that necessary radio resource configurations are exchanged and the CHO with CPAC are executed properly.

In some implementations, the measurement result may include signal quality of cells in the second BS measured by a UE served by the source MN.

In some implementations, the first message may include the measurement result associated with the second BS and a second measurement result associated with the BS.

In some implementations, the second message and the first acknowledgement message may be transmitted on an Xn interface between the BS and the second BS.

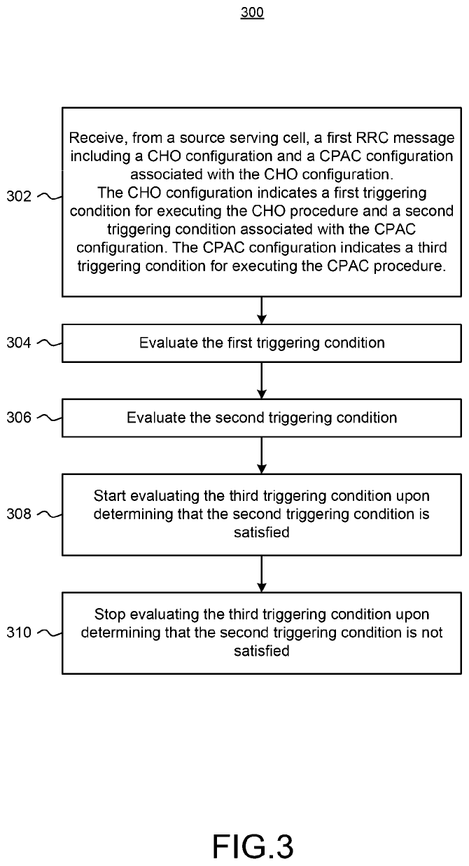

FIG. 3 is a flowchart 300 illustrating a method/process for CHO with CPAC performed by a UE, according to an example implementation of the present disclosure. In action 302, the UE may receive from a source serving cell, a first RRC message including a CHO configuration and a CPAC configuration associated with the CHO configuration. The UE and the serving cell in FIG. 3 may correspond to the UE 102 and the source MN 104 illustrated in FIG. 1, respectively. Action 302 may be performed after action 126 illustrated in FIG. 1 is performed. The CHO configuration and the CPAC configuration in FIG. 3 may correspond to the CHO with CPAC configuration generated by the first BS 106 illustrated in FIG. 1. It should be noted that “the CPAC configuration associated with the CHO configuration” may represent that the CPAC configuration is “linked” to the CHO configuration.

The CHO configuration may indicate a first radio resource configuration corresponding to a target MCG and a PCell for a CHO procedure, a first triggering condition for executing the CHO procedure, and a second triggering condition associated with the CPAC configuration. The second triggering condition may be referred to as a “CHO pre-condition”. The CPAC configuration may indicate a second radio resource configuration corresponding to a target SCG and a PSCell for a CPAC procedure and a third triggering condition for executing the CPAC procedure.

In action 304, the UE may evaluate the first triggering condition. For example, the UE may perform handover to the target MCG and the PCell if the first triggering condition is satisfied. In action 306, the UE may evaluate the second triggering condition. In action 308, the UE may start evaluating the third triggering condition upon determining that the second triggering condition is satisfied. In action 310, the UE may stop evaluating the third triggering condition upon determining that the second triggering condition is not satisfied. For example, the UE may execute the CPAC procedure, such as changing to the target SCG and the PSCell, if the third triggering condition is satisfied.

Because timing of evaluating the third triggering condition depends on the second triggering condition, the UE is not required to evaluate the third triggering condition all the time. This may help reduce unnecessary measurement performed by the UE. For example, the third triggering condition may be related to signal quality of a candidate target SN, and the second triggering condition may be related to signal quality of a candidate target MN. According to action 308 and action 310, the UE may perform measurement on the candidate target SN only when the signal quality of the candidate target MN achieves a specific threshold. For example, the third triggering condition and the second triggering condition may correspond to different threshold values for the signal quality.

In some implementations, the UE may execute the CHO procedure upon determining that the first triggering condition is satisfied and execute the CPAC procedure upon determining that the third triggering condition is satisfied.

In some implementations, the first RRC message may further include a second CHO configuration and a second CPAC configuration associated with the second CHO configuration, and the CPAC configuration is not associated with the second CHO configuration. For example, the first RRC message may include CHO configuration #1, CPAC configuration #1, CHO configuration #2, CPAC configuration #2, where CPAC configuration #1 is linked to CHO configuration #1, CPAC configuration #2 is linked to CHO configuration #2, but CPAC configuration #1 is not linked to CHO configuration #2.

In some implementations, the second CHO configuration (e.g., CHO configuration #2) may indicate a fourth triggering condition for executing a second CHO procedure and a fifth triggering condition associated with the second CPAC configuration (e.g., CPAC configuration #2), and the third triggering condition is not evaluated by the UE in a case that the second triggering condition is not satisfied and the fifth triggering condition is satisfied.

In some implementations, the second triggering condition may correspond to a quality of signal received from the PCell.

In some implementations, the second triggering condition may be indicated by a measurement identifier (ID) in the CHO configuration.

CHO with CPAC Preparation

During the CHO with CPAC Preparation step, the UE may transmit measurement report to the source node, either periodically or based on instructed triggering events. Then, the source node may determine whether to start the preparation of CHO with CPAC.

In some implementations, the UE may perform L1 and/or L3 measurements and report the measured results in the measurement report to the source node. The measurement result may include, but not limited to, signal quality values of the reference resources (e.g., SSB and/or CSI-RS) associated with the neighboring cells, the candidate target cells, SCells, and PSCells to be measured. The signal quality values may include, but not limited to, RSRP values, RSRQ values, RSSI values, and SINR values. The measurement results may be reported by the UE to the source node.

In some implementations, the UE may transmit the measurement report to the source node when the instructed measurement event holds for a Time-to-Trigger (TTT) duration. The instructed measurement event corresponding to the measurement report may be configured through an RRC reconfiguration message to the UE, and may include one or two threshold parameters, an offset parameter, and/or a hysteresis parameter. The threshold and offset parameters configured in the RRC message may be an RSRP value, an RSRQ value, an RSSI value, and/or an SINR value. The hysteresis parameter configured in the RRC message may be a relative/comparison value. The measurement result value may be an RSRP value, an RSRQ value, an RSSI value, and/or an SINR value measured by the UE. The measurement event may take one of the following options:
In some implementations, the UE may consider the entering condition for an event to be satisfied when the measurement result value of the source PCell minus a hysteresis parameter for this event becomes better than a threshold parameter for this event. The UE may consider the leaving condition for the event to be satisfied when the measurement result value of the source PCell plus the hysteresis parameter for this event becomes worse than the threshold parameter for this event.
In some implementations, the UE may consider the entering condition for an event to be satisfied when the measurement result value of the source PCell plus a hysteresis parameter for this event becomes worse than a threshold parameter for this event. The UE may consider the leaving condition for the event to be satisfied when the measurement result value of the source PCell minus the hysteresis parameter for this event becomes better than the threshold parameter for this event.
In some implementations, the UE may consider the entering condition for an event to be satisfied when the measurement result value of the neighbor cell minus a hysteresis parameter for this event becomes better than the measurement result value of the source PCell for an offset for this event. The UE may consider the leaving condition for the event to be satisfied when the measurement result value of the neighbor cell plus the hysteresis parameter for this event becomes worse than the measurement result value of the source PCell for the offset for this event.
In some implementations, the UE may consider the entering condition for an event to be satisfied when the measurement result value of the neighbor cell minus a hysteresis parameter for this event becomes better than a threshold parameter for this event. The UE may consider the leaving condition for the event to be satisfied when the measurement result value of the neighbor cell plus a hysteresis parameter for this event becomes worse than the threshold parameter for this event.
In some implementations, the UE may consider the entering condition for an event to be satisfied when the measurement result value of the source PCell plus a hysteresis parameter for this event becomes worse than a first threshold parameter for this event and the measurement result value of the neighbor cell minus the hysteresis parameter for this event becomes better than a second threshold parameter for this event. The UE may consider the leaving condition for an event to be satisfied when the measurement result value of the source PCell minus a hysteresis parameter for this event becomes better than the first threshold parameter for this event and the measurement result value of the neighbor cell plus the hysteresis parameter for this event becomes worse than the second threshold parameter for this event. The first threshold value and the second threshold value may be the same or different. The first threshold value and the second threshold value may be predefined or preconfigured to the UE. The first threshold value and the second threshold value may be configured by the source node through the RRC message.

In some implementations, if the source node determines to prepare for CHO with CPAC, the source node may determine the candidate target MNs according to the measurement report from the UE, and then the source node may transmit messages (e.g., inter-node RRC message, Xn message, CHO preparation message) associated with the CHO preparation to candidate target MNs. An example of the message associated with the CHO preparation may be referred to the first message illustrated in action 114 in FIG. 1. The message (e.g., an inter-node RRC message) associated with the CHO preparation that is transmitted from the source node to a candidate target MN may include information associated with the UE (e.g., C-RNTI of the UE in the source node, the RRM-configuration including UE inactive time, the basic AS configurations, and/or the QoS flow to DRB mapping rules applied to the UE) and the measurement results (provided by the UE) associated with the cells in the candidate target MN. After transmitting the CHO preparation to all the candidate target MNs, the source node then may wait for the reply from all the candidate target MNs. When the source node receives the responses to the CHO preparation from all the candidate target MNs, the source node may transmit RRC messages and/or IEs to configure the UE with CHO with CPAC configurations.

In some implementations, upon receiving the CHO preparation message, the candidate target MN may perform admission control and determine not to accommodate the UE. In this case, the candidate target MN may respond to the CHO preparation message with an inter-node RRC message including an empty CellGroupConfig IE.

In some implementations, upon receiving the CHO preparation message, the candidate target MN may perform admission control, determine the candidate target PCells and MCGs, prepare the radio resources for each PCell and MCG, and determine the candidate target SNs according to the measurement results corresponding to the candidate target MN and/or SNs that is measured by the UE and provided to the source node and then to the candidate target MN. An example of PCell preparation is shown in action 116 in FIG. 1. The candidate target MN may transmit messages (e.g., an inter-node RRC message, Xn message) associated with the CPAC preparation to candidate target SNs, and the message may include the information associated with the UE and the measurement results associated with the cells in the candidate target SN. An example message associated with the CPAC preparation may refer to the second message illustrated in action 118 in FIG. 1. The message associated with the CPAC preparation may be transmitted on an Xn interface between the candidate target MN and the candidate target SN. The candidate target MN may then wait for the reply of the CPAC preparation from all the candidate target SNs.

In some implementations, upon receiving the message associated with the CPAC preparation, the candidate target SN may perform admission control, and determine not to accommodate the UE. In this case, the candidate target SN may respond to the CPAC preparation message with an inter-node RRC message including an empty CellGroupConfig IE.

In some implementations, upon receiving the message associated with the CPAC preparation, the candidate target SN may perform admission control, and determine whether to accommodate the UE. If the candidate target SN determines not to accommodate the UE, the candidate target SN may not reply to the message associated with the CPAC preparation. For example, from the perspective of the candidate target MN, after transmitting the messages associated with the CPAC preparation to the candidate target SNs, the candidate target MN may receive the response messages only from the candidate target SNs that determine to accommodate the UE.

In some implementations, upon receiving the message associated with the CPAC preparation, the candidate target SN may perform admission control, determine the candidate target PSCells and SCGs, prepare the radio resources for each PSCell and SCG, and reply to the associated candidate target MN with a message (e.g., an inter-node RRC message, Xn message) including prepared PSCells, SCGs, and the corresponding radio resource configurations. An example of the PSCell preparation may refer to action 120 in FIG. 1. An example of the message including the prepared PSCells may refer to the first acknowledgement message illustrated in action 122 in FIG. 1.

In some implementations, upon receiving the reply message associated with the CPAC preparation from all the candidate target SNs, the candidate target MN may reply to the source node in response to receiving the CHO preparation message from the source node.

In some implementations, the candidate target MN may transmit a reply message for each prepared PCell to the source node. The reply message may include the ID of the prepared PCell, the corresponding MCG, the radio resource configuration of the PCell and the MCG, the ID of the prepared associated PSCells, the execution conditions on the associated PSCells, the CPAC pre-conditions to pre-qualify the associated PSCells, the corresponding SCGs, and the radio resource configurations of the PSCells and the SCGs. An example of the reply message may refer to the second acknowledgement message illustrated in action 126 in FIG. 1.

In some implementations, the candidate target MN may transmit a reply message for each prepared PCell, for each prepared PSCell, and for an association. The reply message for a prepared PCell may include the ID of the prepared PCell, the corresponding MCG, the radio resource configuration of the PCell and the MCG. The reply message for a prepared PSCell may include the ID of the prepared PSCell, the execution condition on the PSCell, the CPAC pre-condition to pre-qualify the associated PSCell, the corresponding SCG, and the radio resource configuration of the PSCell and the SCG. The reply message for the association may include a list of pairs of PCell ID and PSCell ID, and a prepared PCell is associated with a prepared PSCell if their IDs are paired.

In some implementations, upon receiving all of the reply messages associated with the CHO preparation from all the candidate PCells, the source node may transmit RRC messages and/or IEs to configure the UE with CHO with CPAC configurations.

CHO with CPAC Configuration

During CHO and CPAC configuration step, the source node may transmit the information/configuration associated with the candidate target PCells and PSCells via RRC signaling to the UE. The source node may prepare one or multiple candidate target PCells and one or multiple candidate target PSCells associated with each candidate target PCells for CHO with CPAC. Then, the source node may generate the RRC message and/or IE (e.g., CellGroupConfig IE) including the information/configuration associated with the candidate target PCells, PSCells, the association between candidate target PCells and candidate target PSCells, and the priority instruction of PSCells. The source node may transmit the generated RRC message and/or IE to the UE. Upon receiving the information/configuration associated with the candidate target PCells and/or PSCells, the UE may store and/or apply the received information/configuration for the CHO with CPAC procedures.

In some implementations, the RRC message and/or IE including the information/configuration associated with the candidate target PCell may include at least one of following: a CHO configuration ID indicating the identity of the CHO information/configuration associated with the candidate target PCell, a first measurement ID indicating the CHO condition, a second measurement ID indicating the CHO pre-condition under which the UE starts to evaluate the candidate target PSCells associated with CPAC information/configuration associated with the CHO, and a conditional RRC configuration that the UE may apply to perform the CHO or CHO with CPAC procedures when the CHO condition occurs. The CHO pre-condition may correspond to the second triggering condition illustrated in FIG. 3. In this disclosure, the term “CHO Configuration” may be used for the RRC message and/or IE including the information/configuration associated with the candidate target PCell.

In some implementations, the source node may configure the CHO condition and the CHO pre-condition of a CHO Configuration through different IEs. In this case, the IE associated with the CHO condition may include one or two threshold parameters, an offset parameter, a hysteresis parameter, and/or a TTT parameter. The IE associated with the CHO pre-condition may include one or two threshold parameters, an offset parameter, a hysteresis parameter, and/or a TTT parameter. The source node may configure each parameter of the CHO pre-condition the same as or different from the corresponding parameter of the CHO condition.

In some implementations, the source node may configure the CHO condition and CHO pre-condition of a CHO Configuration through the same IE. The IE may include a threshold parameter field, an offset parameter field, a hysteresis field, and/or a TTT parameter field.

In some implementations, the threshold parameter field may include one or two threshold parameters for the CHO pre-condition and one or two threshold parameters for the CHO condition. The source node may configure each threshold parameter for CHO pre-condition the same as or different from the corresponding threshold parameter for the CHO condition.

In some implementations, the threshold parameter field may include one or two threshold parameters common to both the CHO pre-condition and the CHO condition.

In some implementations, the offset parameter field may include an offset parameter for the CHO pre-condition and an offset parameter for the CHO condition. The source node may configure the offset parameter for CHO pre-condition the same as or different from the offset parameter for the CHO condition.

In some implementations, the offset parameter field may include a single offset parameter common to both the CHO pre-condition and the CHO condition.

In some implementations, the hysteresis parameter field may include a hysteresis parameter for the CHO pre-condition and a hysteresis parameter for the CHO condition. The source node may configure the hysteresis parameter for CHO pre-condition the same as or different from the hysteresis parameter for the CHO condition.

In some implementations, the hysteresis parameter field may include a single hysteresis parameter common to both the CHO pre-condition and the CHO condition.

In some implementations, the TTT parameter field may include a TTT parameter for the CHO pre-condition and a TTT parameter for the CHO condition. The source node may configure the TTT parameter for CHO pre-condition the same as or different from the TTT parameter for the CHO condition.

In some implementations, the TTT parameter field may include a single TTT parameter common to both the CHO pre-condition and the CHO condition.

In some implementations, the RRC message and/or IE including the information/configuration associated with the candidate target PSCell may include at least one of following: a CPAC configuration ID indicating the identity of the CPAC information/configuration associated with the candidate target PSCell, a first measurement ID indicating the CPAC execution condition, a second measurement ID indicating the CPAC pre-condition under which the CPAC Candidate Configuration is qualified, and a configuration that the UE may apply when the UE performs the CPAC execution. In this disclosure, the term “CPAC Configuration” may be used for the RRC message and/or IE including the information/configuration associated with the candidate target PSCell.

In some implementations, the source node may configure the CPAC condition and the CPAC pre-condition of a CPAC Configuration through different IEs to the UE. In this case, the IE associated with the CPAC condition may include one or two threshold parameters, an offset parameter, a hysteresis parameter, and/or a TTT parameter. The IE associated with the CPAC pre-condition may include one or two threshold parameters, an offset parameter, a hysteresis parameter, and/or a TTT parameter. The source node may configure each parameter of the CPAC pre-condition the same as or different from the corresponding parameter of the CPAC condition.

In some implementations, the source node may configure the CPAC condition and CPAC pre-condition of a CPAC Configuration through the same IE to the UE. The IE may include a threshold parameter field, an offset parameter field, a hysteresis parameter field, and/or a TTT parameter field.

In some implementations, the threshold parameter field may include one or two threshold parameters for the CPAC pre-condition and one or two threshold parameters for the CPAC condition. The source node may configure each threshold parameter for CPAC pre-condition the same as or different from the corresponding threshold parameter for the CPAC condition.

In some implementations, the threshold parameter field may include one or two threshold parameters common to both the CPAC pre-condition and the CPAC condition.

In some implementations, the offset parameter field may include an offset parameter for the CPAC pre-condition and an offset parameter for the CPAC condition. The source node may configure the offset parameter for CPAC pre-condition the same as or different from the offset parameter for the CPAC condition.

In some implementations, the offset parameter field may include a single offset parameter common to both the CPAC pre-condition and the CPAC condition.

In some implementations, the hysteresis parameter field may include a hysteresis parameter for the CPAC pre-condition and a hysteresis parameter for the CPAC condition. The source node may configure the hysteresis parameter for CPAC pre-condition the same as or different from the hysteresis parameter for the CPAC condition.

In some implementations, the hysteresis parameter field may include a single hysteresis parameter common to both the CPAC pre-condition and the CPAC condition.

In some implementations, the TTT parameter field may include a TTT parameter for the CPAC pre-condition and a TTT parameter for the CPAC condition. The source node may configure the TTT parameter for CPAC pre-condition the same as or different from the TTT parameter for the CPAC condition.

In some implementations, the TTT parameter field may include a single TTT parameter common to both the CPAC pre-condition and the CPAC condition.

In this disclosure, the term “Linking Message” may be used for the RRC message and/or IE including the information/configuration associated with the association between candidate target PCells and the candidate target PSCells.

In some implementations, the Linking Message may include an association list which pairs CHO Configuration ID and CPAC Configuration ID, and may include a priority instruction of PSCells. In some implementations, a CHO Configuration and a CPAC Configuration is associated if the CHO Configuration ID and the CPAC Configuration ID are paired in the association list.

In some implementations, the Linking Message may include an association list which pairs CHO Configuration and CPAC Configuration. The priority instruction of PSCells may be contained in another RRC message and/or IE, which may be referred to as “Priority Message”.

In some implementations, the source node may configure one or more CHO Configurations and/or one or more CPAC Configuration to the UE via RRC signaling. In some implementations, upon receiving the RRC signaling, the UE may release the stored information/configuration associated with the candidate target PCells and/or PSCells, if any, and then store and/or apply the newly received information/configuration associated with the candidate target PCells and/or PSCells. It should be noted that the stored information/configuration associated with the candidate target PCells and/or PSCells may be included in the previous RRC message and/or IE received by the UE from the source node, where the RRC message and/or IE may include the information/configuration associated with the candidate target PCells and/or PSCells.

In some implementations, the source node may configure one or more CHO Configurations and/or one or more CPAC Configurations through an RRC message. In this disclosure, “Conditional Delta Configuration” may be used for the RRC message including one or more CHO Configurations and/or one or more CPAC Configurations.

In some implementations, the RRC message may include a set of CHO Configurations and/or CPAC Configurations to be added and/or modified.

In some implementations, the RRC message may include a set of CHO Configurations and/or CPAC Configurations to be released.

In some implementations, the RRC message may include a first set of CHO Configurations and/or CPAC Configurations to be applied, and a second set of CHO Configurations and/or CPAC Configurations to be released.

In some implementations, upon receiving the Conditional Delta Configuration, the UE may apply the set of CHO Configurations and/or CPAC Configurations to be added and/or modified. The UE may check whether the IDs of the CHO Configurations and/or CPAC Configurations in the set exist in the stored information/configuration. If an ID of a CHO Configuration and/or a CPAC Configuration exists in the stored information/configuration, the UE may perform the modification of CHO and/or CPAC Configuration to the corresponding CHO and/or CPAC Configuration; otherwise, the UE may perform the addition of CHO and/or CPAC Configuration to the corresponding CHO and/or CPAC Configuration. The UE may keep the stored information/configuration that are not associated with the set of CHO Configurations and/or CPAC Configurations to be added and/or modified.

In some implementations, upon receiving the Conditional Delta Configuration, the UE may release the set of CHO Configurations and/or CPAC Configurations to be released. The UE may keep the stored information/configuration that are not associated with the set of CHO Configurations and/or CPAC Configurations to be released.

In some implementations, upon receiving the Conditional Delta Configuration, the UE may apply a first set of CHO Configurations and/or CPAC Configurations to be added and/or modified, and the UE may release a second set of CHO Configurations and/or CPAC Configurations to be released. For the first set of CHO Configurations and/or CPAC Configurations to be added and/or modified, the UE may check whether the IDs of the CHO Configurations and/or CPAC Configurations in the set exist in the stored information/configuration. If an ID of a CHO Configuration and/or a CPAC Configuration exists in the stored information/configuration, the UE may perform the modification of CHO and/or CPAC Configuration to the corresponding CHO and/or CPAC Configuration; otherwise, the UE may perform the addition of CHO and/or CPAC Configuration to the corresponding CHO and/or CPAC Configuration. The UE may keep the stored information/configuration that are not associated with the set of CHO Configurations and/or CPAC Configurations to be added, and/or modified, and/or released.

In some implementations, when a UE performs the modification of a CHO Configuration, the UE may release the stored information/configuration associated with the candidate target PCell, if any, and then store and/or apply the newly received information/configuration associated with the candidate target PCell. It should be noted that the stored information/configuration associated with the candidate target PCell may be included in the previous RRC message and/or IE received by the UE from the source node, where the RRC message and/or IE may include the information/configuration associated with the candidate target PCell. In this disclosure, “CHO Candidate Configuration” may be used for the stored information/configuration associated with the candidate target PCell.

In some implementations, when a UE performs the modification of a CPAC Configuration, the UE may release the stored information/configuration associated with the candidate target PSCell, if any, and then store and/or apply the newly received information/configuration associated with the candidate target PSCell. It should be noted that the stored information/configuration associated with the candidate target PSCell may be included in the previous RRC message and/or IE received by the UE from the source node, where the RRC message and/or IE may include the information/configuration associated with the candidate target PSCell. In this disclosure, “CPAC Candidate Configuration” may be used for the stored information/configuration associated with the candidate target PSCell.

In some implementations, when a UE performs the addition of a CHO Configuration, the UE may store and/or apply the newly received information/configuration associated with the candidate target PCell.

In some implementations, when a UE performs the addition of a CPAC Configuration, the UE may store and/or apply the newly received information/configuration associated with the candidate target PSCell.

In some implementations, when a UE performs the release of a CHO Configuration, the UE may release the stored information/configuration associated with the candidate target PCell.

In some implementations, when a UE performs the release of a CPAC Configuration, the UE may release the stored information/configuration associated with the candidate target PSCell.

In some implementations, upon receiving the Linking Message, the UE may release the stored information/configuration associated with the CHO Candidate Configuration ID and the CPAC Candidate Configuration ID in the association between CHO Candidate Configuration and CPAC Candidate Configuration, if any, and then store and/or apply the newly received information/configuration associated with the CHO Candidate Configuration ID and the CPAC Candidate Configuration ID. It should be noted that the stored information/configuration associated with the CHO Candidate Configuration ID and the CPAC Candidate Configuration ID may be included in the previous RRC message and/or IE received by the UE from the source node, where the RRC message and/or IE may include the information/configuration associated with the CHO Candidate Configuration ID and the CPAC Candidate Configuration ID. In some implementation, if a CHO Candidate Configuration and a CPAC Candidate Configuration are associated, the UE may consider that it is allowed to jointly execute CHO Candidate Configuration and a CPAC Candidate Configuration in a CHO with CPAC procedure (e.g., jointly apply the RRC reconfiguration in the CHO Candidate Configuration and the RRC reconfiguration in the CPAC Candidate Configuration). In this disclosure, “Linking Configuration” may be used for the stored information/configuration associated with the CHO Candidate Configuration ID and the CPAC Candidate Configuration ID.

In some implementations, the Linking Message may include multiple cho-cpac-Association IEs, each of which may include a CHO Candidate Configuration ID and a CPAC Candidate Configuration ID. Table 1 illustrates fields in an example Linking Message according to an example implementation of the present disclosure.

TABLE 1

```
cho-cpac-Association SEQUENCE{
  cho-ConfigurationId CondReconfigId,
  cpac-ConfigurationId CondReconfigId}
```

In some implementations, a UE may consider that a CHO Candidate Configuration and a CPAC Candidate Configuration are associated if the CHO Candidate Configuration ID, identifying the CHO Candidate Configuration, and the CPAC Candidate Configuration ID, identifying the CPAC Configuration appear in the same cho-cpac-Association IE (encapsulated) in the Linking Message.

In some implementations, the UE may release the stored information/configuration associated with the priority instruction of PSCells and then store and/or apply the newly received information/configuration associated with the priority instruction of PSCells if the information/configuration associated with the priority instruction of PSCells is included in the Linking Message. In this disclosure, “Priority Instruction” may be used for the stored information/configuration associated with the priority instruction of PSCells.

In some implementations, upon receiving the Priority Message, the UE may release the Priority Instruction and then store and/or apply the newly received information/configuration in the Priority Message.

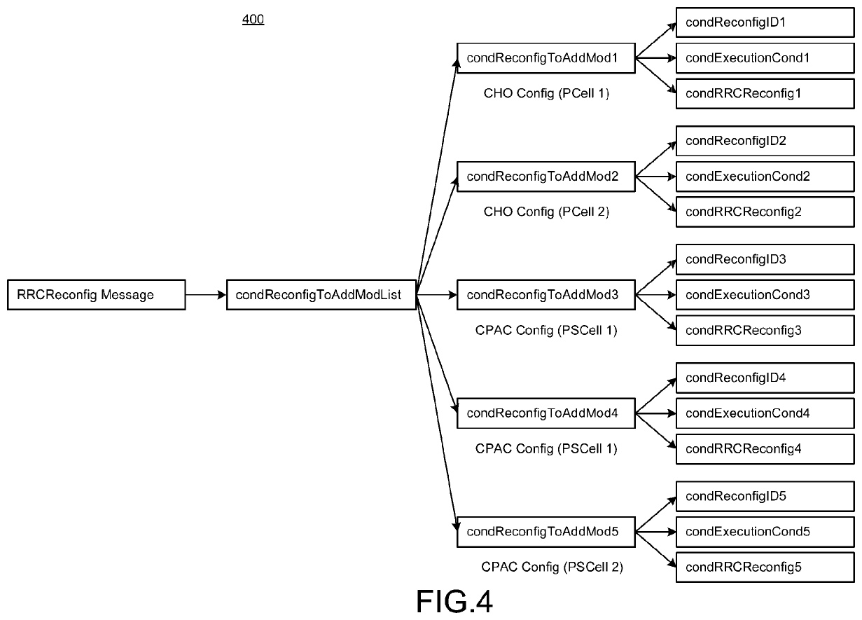

FIG. 4 illustrates structure of an RRC message 400 including a CHO with CPAC configuration, according to an example implementation of the present disclosure. The source node may transmit the RRC message 400 to the UE. The RRC message may be an RRC Reconfiguration message, which may include a CondReconfigToAddModList IE. The CondReconfigToAddModList IE may include one or more CondReconfigToAddMod IE, each of which corresponds to a CHO Configuration and/or a CPAC Configuration. A CondReconfigToAddMod IE may include a condReconfigId IE, a condExecutionCond IE, and a condRRCReconfig IE. The pre-condition of a CHO and/or a CPAC Configuration may be included along with the CHO and/or CPAC condition in the condExecutionCond IE, or it may be included in a separate condExecutionCond IE with an RRC field indicating that it is a CHO and/or CPAC pre-condition.

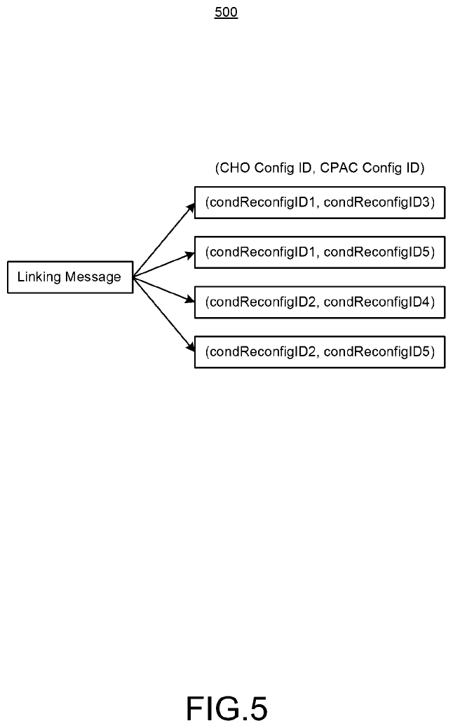

FIG. 5 illustrates structure of a Linking Message 500 according to an example implementation of the present disclosure. The source node may transmit the Linking Message 500 to the UE. The Linking Message 500 may include a list of IEs with SEQUENCE structures (e.g., LinkingToAddMod IEs). Each of the IEs with the SEQUENCE structure in the Linking Message 500 may include two condReconfigId IEs, which are associated with a CHO Configuration and a CPAC Configuration respectively. A source node may indicate that a CHO Configuration and a CPAC Configuration are associated by configuring an IE, which includes the condReconfigId IEs corresponding to the CHO Configuration and the CPAC Configuration, in the Linking Message. For example, the first condReconfig IE may be associated with the CHO Configuration and the second condReconfig IE may be associated with the CPAC Configuration. For example, the first condReconfig IE may be associated with the CPAC Configuration and the second condReconfig IE may be associated with the CHO Configuration.

CHO with CPAC Evaluation and Execution

During the CHO and CPAC evaluation step, the UE evaluates the CHO conditions of the candidate target PCells, and, if configured, the CPAC condition of the candidate target PSCells. Based on the measurement configuration, the UE may perform L1/L3 measurement on candidate target PCells and candidate target PSCells as the evaluations on the CHO and/or CPAC conditions. When some CHO conditions occur, the UE may perform (or execute) CHO or CHO with CPAC execution.

In some implementations, the measurement result may include, but not limited to, the RSRP values and/or the RSRQ values of the reference resources associated with the neighboring cells, the candidate target cells, SCells, and PSCells to be measured.

In some implementations, the UE may trigger a CHO condition when the entering condition of CHO event is considered to be satisfied for the TTT duration for the CHO condition.

In some implementations, the UE may consider the entering condition for a CHO event to be satisfied when the measurement result value of the CHO-associated candidate target PCell minus the hysteresis parameter for the CHO condition becomes better than the measurement result value of the source PCell plus the offset parameter for the CHO condition.

In some implementations, the UE may consider the entering condition for a CHO event to be satisfied when the measurement result value of the CHO-associated candidate target PCell minus the hysteresis parameter for the CHO condition becomes better than the threshold parameter for the CHO condition.

In some implementations, the UE may consider the entering condition for a CHO event to be satisfied when the measurement result value of the source PCell plus the hysteresis parameter for the CHO condition becomes worse than the first threshold parameter for the CHO condition and the measurement value of the CHO-associated candidate target PCell minus the hysteresis parameter for the CHO condition becomes better than the second threshold parameter for the CHO condition.

In some implementations, the UE may trigger a CHO pre-condition when the entering condition of CHO pre-event is considered to be satisfied for the TTT duration for the CHO pre-condition.

In some implementations, the UE may consider the entering condition for a CHO pre-event to be satisfied when the measurement result value of the CHO-associated candidate target PCell minus the hysteresis parameter for the CHO pre-condition becomes better than the measurement result value of the source PCell plus the offset parameter for the CHO pre-condition.

In some implementations, the UE may consider the entering condition for a CHO pre-event to be satisfied when the measurement result value of the CHO-associated candidate target PCell minus the hysteresis parameter for the CHO pre-condition becomes better than the threshold parameter for the CHO pre-condition.

In some implementations, the UE may consider the entering condition for a CHO pre-event to be satisfied when the measurement result value of the source PCell plus the hysteresis parameter for the CHO pre-condition becomes worse than the first threshold parameter for the CHO pre-condition and the measurement value of the CHO-associated candidate target PCell minus the hysteresis parameter for the CHO pre-condition becomes better than the second threshold parameter for the CHO pre-condition.

In some implementations, the UE may trigger a CPAC condition when the entering condition of CPAC event is considered to be satisfied for the TTT duration for the CPAC condition. In some implementations, the UE may trigger a CPAC leaving condition when the leaving condition of CPAC event is considered to be satisfied for the TTT duration for the CPAC condition.

In some implementations, the UE may consider the entering condition for a CPAC event to be satisfied when the measurement result value of the CPAC-associated candidate target PSCell minus the hysteresis parameter for the CPAC condition becomes better than the measurement result value of the source PCell or the source PSCell plus the offset parameter for the CPAC condition. In some implementations, the UE may consider the leaving condition for a CPAC event to be satisfied when the measurement result value of the CPAC-associated candidate target PSCell plus the hysteresis parameter for the CPAC condition becomes worse than the measurement result value of the source PCell or the source PSCell plus the offset parameter for the CPAC condition.

In some implementations, the UE may consider the entering condition for a CPAC event to be satisfied when the measurement result value of the CPAC-associated candidate target PSCell minus the hysteresis parameter for the CPAC condition becomes better than the threshold parameter for the CPAC condition. In some implementations, the UE may consider the leaving condition for a CPAC event to be satisfied when the measurement result value of the CPAC-associated candidate target PSCell plus the hysteresis parameter for the CPAC condition becomes worse than the threshold parameter for the CPAC condition.

In some implementations, the UE may consider the entering condition for a CPAC event to be satisfied when the measurement result value of the source PCell or source PSCell plus the hysteresis parameter for the CPAC condition becomes worse than the first threshold parameter for the CPAC condition and the measurement value of the CPAC-associated candidate target PSCell minus the hysteresis parameter for the CPAC condition becomes better than the second threshold parameter for the CPAC condition. In some implements, the UE may consider the leaving condition for a CPAC event to be satisfied when the measurement result value of the source PCell or source PSCell minus the hysteresis parameter for the CPAC condition becomes better than the first threshold parameter for the CPAC condition and the measurement value of the CPAC-associated candidate target PSCell plus the hysteresis parameter for the CPAC condition becomes worse than the second threshold parameter for the CPAC condition.

In some implementations, the UE may trigger a CPAC pre-condition when the entering condition of CPAC pre-event is considered to be satisfied for the TTT duration for the CPAC pre-condition.

In some implementations, the UE may consider the entering condition for a CPAC pre-event to be satisfied when the measurement result value of the CPAC-associated candidate target PSCell minus the hysteresis parameter for the CPAC pre-condition becomes better than the measurement result value of the source PCell or the source PSCell plus the offset parameter for the CPAC pre-condition.

In some implementations, the UE may consider the entering condition for a CPAC pre-event to be satisfied when the measurement result value of the CPAC-associated candidate target PSCell minus the hysteresis parameter for the CPAC pre-condition becomes better than the threshold parameter for the CPAC pre-condition.

In some implementations, the UE may consider the entering condition for a CPAC pre-event to be satisfied when the measurement result value of the source PCell or the source PSCell plus the hysteresis parameter for the CPAC pre-condition becomes worse than the first threshold parameter for the CPAC pre-condition and the measurement value of the CPAC-associated candidate target PSCell minus the hysteresis parameter for the CPAC pre-condition becomes better than the second threshold parameter for the CPAC pre-condition.

In some implementations, when a UE is configured with some CHO Candidate Configurations, the UE may evaluate the CHO conditions of the candidate target PCells. In some implementations, when some CHO conditions occur, the UE may select a target PCell associated with a CHO Candidate Configuration whose CHO condition occurs, with priority indicated by the source node or by UE's implementation, and the UE may perform CHO execution to the target PCell.

In some implementations, when a UE is configured with some CHO Candidate Configurations, CPAC Candidate Configurations, with or without Linking Configurations, and with or without Priority Instruction, the UE may evaluate the CHO conditions of the candidate target PCells and the CPAC conditions of the candidate target PSCells. In some implementations, when a UE is configured with some CHO Candidate Configurations, CPAC Candidate Configurations, and with or without Linking Configurations, the UE may first evaluate the CHO conditions of the candidate target PCells, and when the CHO pre-conditions of some CHO Candidate Configurations occur, the UE may start to evaluate the CPAC conditions of the candidate target PSCells whose CPAC Candidate Configurations are associated with the CHO Candidate Configuration. As illustrated in action 308 in FIG. 3, the UE may start evaluating the third triggering condition (e.g., CPAC condition) upon determining that the second triggering condition (e.g., CHO pre-condition) is satisfied. During the CPAC evaluation, when the CHO pre-conditions are not met, the UE may stop evaluating the CPAC conditions of the candidate target PSCells whose CPAC Candidate Configurations are associated with the CHO Candidate Configurations whose CHO pre-conditions are not met and not associated with the CHO Candidate Configurations whose CHO pre-conditions are met. As illustrated in action 310 in FIG. 3, the UE may stop evaluating the third triggering condition (e.g., CPAC condition) upon determining that the second triggering condition (e.g., CHO pre-condition) is not satisfied.

In some implementations, when the UE triggers some CPAC conditions before any CHO execution, the UE may determine these CPAC conditions as the Qualified CPAC Candidate Configurations, and the UE may continue evaluating the conditions for the CHO and CPAC. In some implementations, when a UE triggers some CPAC leaving conditions for some Qualified CPAC Candidate Configurations before any CHO execution, the UE may determine to cancel the qualification of these Qualified CPAC Candidate Configurations, and the UE may determine them as ordinary CPAC Candidate Configurations.

In some implementations, when the UE triggers some CPAC pre-conditions before any CHO execution, the UE may determine the CPAC Candidate Configurations whose CPAC pre-conditions occur as the Pre-Qualified CPAC Candidate Configurations, and the UE may continue evaluating the conditions of the CHO and CPAC.

In some implementations, when a UE considers the condition of the CPAC event to be not satisfied for some Pre-Qualified CPAC Candidate Configurations, the UE may determine to cancel the pre-qualification of those Pre-Qualified CPAC Candidate Configurations, and the UE may determine them as ordinary CPAC Candidate Configurations.

In some implementations, when the CPAC conditions of some CPAC Candidate Configurations, including the Pre-Qualified CPAC Candidate Configurations, occur before any CHO execution, the UE may determine the CPAC Candidate Configurations as the Qualified CPAC Candidate Configurations.

In some implementations, when the UE considers some CPAC leaving conditions to be satisfied for some Qualified CPAC Candidate Configurations before any CHO execution, the UE may determine to cancel the qualification of the Qualified CPAC Candidate Configurations, and the UE may determine them as ordinary CPAC Candidate Configurations.

In some implementations, when CHO pre-conditions are not met for some CHO Candidate Configurations, the UE may determine to cancel the pre-qualification and/or the qualification of the Pre-Qualified and/or Qualified CPAC Candidate Configurations that are associated with the CHO Candidate Configurations whose CHO pre-conditions are not met and not associated with the CHO Candidate Configurations whose CHO pre-conditions are met, and the UE may set them as ordinary CPAC Candidate Configurations.

In some implementations, when some CHO conditions occur, the UE may select a target PCell whose CHO condition occurs, with the priority indicated by the source node.

In some implementations, if the target CHO Candidate Configuration is associated with at least one associated Qualified CPAC Candidate Configuration and with at least one associated Pre-Qualified CPAC Candidate Configuration, the UE may select, with the priority indicated by Priority Instruction or by UE's implementation, a target PSCell and/or a backup target PSCell associated with the Qualified and/or Pre-Qualified CPAC Candidate Configuration.

In some implementations, if the target PSCell is associated with a Qualified CPAC Candidate Configuration, the UE may perform CHO execution to the target PCell and then CPAC execution to the target PSCell, and the UE may stop any evaluation on CHO and CPAC conditions.

In some implementations, if the target PSCell is associated with a Pre-Qualified CPAC Candidate Configuration, the UE may select, with the priority indicated by Priority Instruction or by UE's implementation, a backup target PSCell associated with a Qualified CPAC Candidate Configuration. The UE may perform CHO execution to the target PCell and continue evaluating the CPAC condition of the target PSCell, and the UE may stop any evaluation on CHO conditions and CPAC conditions other than the Pre-Qualified CPAC. If the CPAC condition of the target PSCell occurs, the UE may perform CPAC execution to the target PSCell after the CHO execution to the target PCell, and the UE may stop any evaluation on CPAC conditions. If the target PSCell fails to meet the associated CPAC condition, the UE may perform CPAC execution to the backup PSCell after the CHO execution to the target PCell, and the UE may stop any evaluation on CPAC conditions.

In some implementations, if the target CHO Candidate Configuration is associated with at least one associated Qualified CPAC Candidate Configuration and without any associated Pre-Qualified CPAC Candidate Configuration, the UE may select, with the priority indicated by Priority Instruction or by UE's implementation, a target PSCell associated with a Qualified CPAC Candidate Configuration. The UE may perform CHO execution to the target PCell and then CPAC execution to the target PSCell, and the UE may stop any evaluation on CHO and CPAC conditions.

In some implementations, if the target CHO Candidate Configuration is associated with at least one associated Pre-Qualified CPAC Candidate Configuration and without any associated Qualified CPAC Candidate Configuration, the UE may perform CHO execution to the target PCell and continue evaluating the CPAC conditions of the Pre-Qualified CPAC, and the UE may stop any evaluation on CHO conditions and CPAC conditions other than the Pre-Qualified CPAC. In some implementations, if some PSCells associated with associated Pre-Qualified CPAC Candidate Configurations fail to meet the associated CPAC conditions, the UE may stop the evaluation on CPAC conditions associated with these PSCells. If some PSCells associated with associated Pre-Qualified CPAC Candidate Configurations meet the associated CPAC conditions, the UE may select a target PSCell whose CPAC condition occurs, perform CPAC execution to the target PSCell, and stop any evaluation on CPAC conditions. In some implementations, when all the PSCells associated with associated Pre-Qualified CPAC Candidate Configurations fails to meet the associated CPAC conditions, the UE may not perform CPAC to any PSCell and stop the evaluation on any CPAC conditions.

In some implementations, if the target CHO Candidate Configuration is associated with neither associated Pre-Qualified CPAC Candidate Configuration nor associated Qualified CPAC Candidate Configuration, the UE may perform CHO execution to the target PCell and may not perform CPAC to any PSCell, and the UE may stop any evaluation on CHO conditions and CPAC conditions.

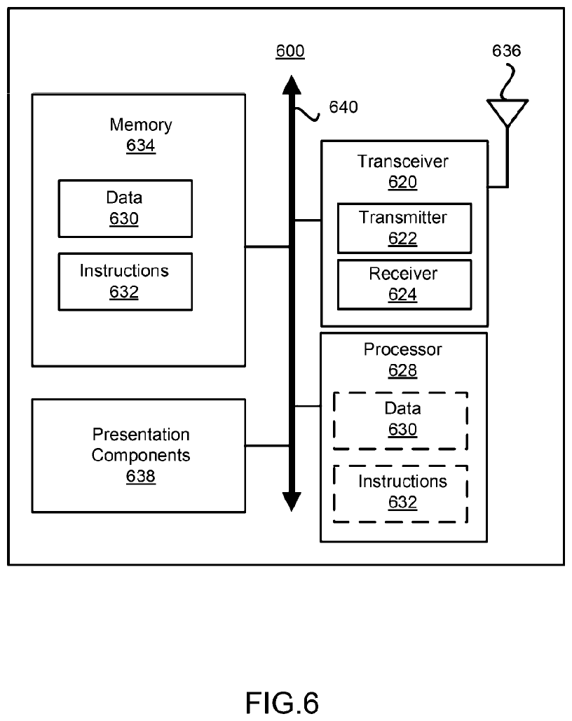

FIG. 6 is a block diagram illustrating a node 600 for wireless communication in accordance with various aspects of the present disclosure. As illustrated in FIG. 6, a node 600 may include a transceiver 620, a processor 628, a memory 634, one or more presentation components 638, and at least one antenna 636. The node 600 may also include a radio frequency (RF) spectrum band module, a BS communications module, a network communications module, and a system communications management module, Input/Output (I/O) ports, I/O components, and a power supply (not illustrated in FIG. 6).

Each of the components may directly or indirectly communicate with each other over one or more buses 640. The node 600 may be a UE or a BS that performs various functions disclosed with reference to FIGS. 1 through 5.

The transceiver 620 has a transmitter 622 (e.g., transmitting/transmission circuitry) and a receiver 624 (e.g., receiving/reception circuitry) and may be configured to transmit and/or receive time and/or frequency resource partitioning information. The transceiver 620 may be configured to transmit in different types of subframes and slots including, but not limited to, usable, non-usable, and flexibly usable subframes and slot formats. The transceiver 620 may be configured to receive data and control channels.

The node 600 may include a variety of computer-readable media. Computer-readable media may be any available media that may be accessed by the node 600 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 634 may include computer-storage media in the form of volatile and/or non-volatile memory. The memory 634 may be removable, non-removable, or a combination thereof. Example memory may include solid-state memory, hard drives, optical-disc drives, etc. As illustrated in FIG. 6, the memory 634 may store a computer-readable and/or computer-executable instructions 632 (e.g., software codes) that are configured to, when executed, cause the processor 628 to perform various functions disclosed herein, for example, with reference to FIGS. 1 through 5. Alternatively, the instructions 632 may not be directly executable by the processor 628 but may be configured to cause the node 600 (e.g., when compiled and executed) to perform various functions disclosed herein.

The processor 628 (e.g., having processing circuitry) may include an intelligent hardware device, e.g., a Central Processing Unit (CPU), a microcontroller, an ASIC, etc. The processor 628 may include memory. The processor 628 may process the data 630 and the instructions 632 received from the memory 634, and information transmitted and received via the transceiver 620, the baseband communications module, and/or the network communications module. The processor 628 may also process information to send to the transceiver 620 for transmission via the antenna 636 to the network communications module for transmission to a CN.

One or more presentation components 638 may present data indications to a person or another device. Examples of presentation components 638 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a first Base Station (BS) for Conditional Handover (CHO) with Conditional Primary Secondary Cell Group (SCG) Cell (PSCell) Addition/Change (CPAC), the method comprising:
receiving, from a source Master Node (MN), a first message indicating the first BS as a candidate target MN for a CHO with CPAC procedure;
transmitting, to a second BS, a second message indicating the second BS as a candidate target Secondary Node (SN) for the CHO with CPAC procedure, the second message including a first measurement result associated with the second BS;
receiving, from the second BS, a first acknowledgement message including a first radio resource configuration corresponding to an SCG and a PSCell associated with the second BS; and
transmitting, to the source MN, a second acknowledgement message including an identifier (ID) of a Primary Cell (PCell), a second radio resource configuration corresponding to a Master Cell Group (MCG) and the PCell associated with the first BS, an ID of the PSCell, the first radio resource configuration, and an execution condition for the PSCell.

2-4. (canceled)

5. A first Base Station (BS) for Conditional Handover (CHO) with Conditional Primary Secondary Cell Group (SCG) Cell (PSCell) Addition/Change (CPAC), the first BS comprising:
at least one processor; and
at least one memory-non-transitory computer-readable medium coupled to the at least one processor and storing one or more computer-executable instructions that, when executed by the at least one processor, cause the first BS to:
receive, from a source Master Node (MN), a first message indicating the first BS as a candidate target MN for a CHO with CPAC procedure;
transmit, to a second BS, a second message indicating the second BS as a candidate target Secondary Node (SN) for the CHO with CPAC procedure, the second message including a first measurement result associated with the second BS;
receive, from the second BS, a first acknowledgement message including a first radio resource configuration corresponding to an SCG and a PSCell associated with the second BS; and
transmit, to the source MN, a second acknowledgement message including an identifier (ID) of a Primary Cell (PCell), a second radio resource configuration corresponding to a Master Cell Group (MCG) and the PCell associated with the first BS, an ID of the PSCell, the first radio resource configuration, and an execution condition for the PSCell.

6. The first BS of claim 5, wherein the first measurement result includes signal quality of cells in the second BS measured by a User Equipment (UE) served by the source MN.

7. The first BS of claim 5, wherein the first message includes the first measurement result associated with the second BS and a second measurement result associated with the first BS.

8. The first BS of claim 5, wherein the second message and the first acknowledgement message are transmitted on an Xn interface between the first BS and the second BS.

9. A User Equipment (UE) for Conditional Handover (CHO) with Conditional Primary Secondary Cell Group (SCG) Cell (PSCell) Addition/Change (CPAC), the UE comprising:
at least one processor; and
at least one non-transitory computer-readable medium coupled to the at least one processor and storing one or more computer-executable instructions that, when executed by the at least one of the one or more processors, cause the UE to:
receive, from a source serving cell, a first Radio Resource Control (RRC) message including a first CHO configuration and a first CPAC configuration associated with the first CHO configuration, wherein:
the first CHO configuration indicates a first radio resource configuration corresponding to a target Master Cell Group (MCG) and a Primary Cell (PCell) for a CHO with CPAC procedure, a first execution condition for the PCell, and a first triggering condition associated with the first CPAC configuration, and
the first CPAC configuration indicates a second radio resource configuration corresponding to a target SCG and a PSCell for the CHO with CPAC procedure and a second execution condition for the PSCell;
determine whether the first execution condition for the PCell is satisfied;
apply the first radio resource configuration corresponding to the PCell upon determining that the first execution condition for the PCell is satisfied;
determine whether the first triggering condition is satisfied;
start evaluating the second execution condition for the PSCell upon determining that the first triggering condition is satisfied; and
stop evaluating the second execution condition for the PSCell upon determining that the first triggering condition is not satisfied.

10. The UE of claim 9, wherein the one or more computer-executable instructions, when executed by the at least one processor, further cause the UE to:
apply the second radio resource configuration corresponding to the PSCell upon determining that the second execution condition for the PSCell is satisfied.

11. The UE of claim 9, wherein:
the first RRC message further includes a second CHO configuration and a second CPAC configuration associated with the second CHO configuration, and
the first CPAC configuration is not associated with the second CHO configuration.

12. The UE of claim 11, wherein:
the second CHO configuration indicates a second triggering condition associated with the second CPAC configuration, and
the second execution condition for the PSCell is not evaluated by the UE in a case that the first triggering condition is not satisfied and the second triggering condition is satisfied.

13. The UE of claim 9, wherein the first triggering condition corresponds to a quality of signal received from the PCell.

14. The UE of claim 9, wherein the first triggering condition is indicated by a measurement identifier (ID) in the first CHO configuration.
